(19) United States
(12) Patent Application Publication
(10) Pub. No.: US 2026/0079068 A1
(43) Pub. Date: Mar. 19, 2026

(54) INLINE BATTERY ELECTROLYTE LEAK DETECTION

(71) Applicant: GM GLOBAL TECHNOLOGY OPERATIONS LLC, Detroit, MI (US)

(72) Inventors: Hassan Ghassemi-Armaki, Northville, MI (US); Blair E. CARLSON, Ann Arbor, MI (US); Junjie MA, Novi, MI (US); Masoud MOHAMMADPOUR, Washington Township, MI (US); William Reginald COLLIN, Dearborn, MI (US); Cedrick D. RILEY, Northville, MI (US); Ratandeep Singh KUKREJA, Auburn Hills, MI (US); Ravi MAHESHWARI, Warren, MI (US); Randolph ZEITVOGEL, Beverly Hills, MI (US)

(21) Appl. No.: 18/888,473

(22) Filed: Sep. 18, 2024

(51) Int. Cl. G01M 3/20; H01M 10/42

(52) U.S. Cl. CPC G01M 3/205; H01M 10/4228; H01M 10/4285

(57) ABSTRACT

A system configured to detect leakage of an electrolyte from a battery cell. The system includes: a probe configured to contact the battery cell and create an air-tight connection between the probe and the battery cell over a fill port of the battery cell that has been closed with a seal; a pump in fluid communication with the probe, the pump configured to draw a vacuum through the probe; a housing defining a chamber including a window, the probe extends from the housing, the pump is connected to the housing to draw the vacuum through the probe into the chamber; and a sensor configured to detect presence of the electrolyte within the chamber pulled from the battery cell through the seal of the fill port by the vacuum generated by the pump, presence of the electrolyte within the chamber is indicative of the seal of the fill port of the battery cell being compromised.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to inline battery electrolyte leak detection.

Battery cells are used to power a wide variety of devices and systems. For example, battery cells are power sources for battery electric vehicles (BEVs), plug-in hybrid electric vehicles (PHEVs), and hybrid electric vehicles (HEVs). Various types of battery cells may be used, such as prismatic battery cells, for example. Each cell includes an outer case, which is sealed to prevent the contents thereof from exiting the cell. Battery cell manufacturing processes include quality control checks to ensure the integrity of each battery cell.

### SUMMARY

The present disclosure provides for, in various features, a system configured to detect leakage of an electrolyte from a battery cell. The system includes: a probe configured to contact the battery cell and create an air-tight connection between the probe and the battery cell over a fill port of the battery cell that has been closed with a seal; a pump in fluid communication with the probe, the pump configured to draw a vacuum through the probe; a housing defining a chamber including a window, the probe extends from the housing, the pump is connected to the housing to draw the vacuum through the probe into the chamber; and a sensor configured to detect presence of the electrolyte within the chamber pulled from the battery cell through the seal of the fill port by the vacuum generated by the pump, presence of the electrolyte within the chamber is indicative of the seal of the fill port of the battery cell being compromised.

In further features, the battery cell is a prismatic cell.

In further features, the seal of the fill port includes a weld.

In further features, the pump is configured to draw a vacuum of 0.1 psi.-5 psi.

In further features, the window includes silicon glass that is transparent to infrared radiation.

In further features, the chamber defines a chamber volume that is greater than a probe volume defined by the probe.

In further features, the chamber has bulbous shape.

In further features, the sensor includes an infrared camera pointing at the window, the infrared camera configured to detect the electrolyte within the chamber pulled out of the battery cell through the seal of the fill port by the vacuum generated by the pump.

In further features, the infrared camera includes a filter configured to block infrared radiation outside of a wavelength range of 7-12 μm.

In further features, a volatile organic compound sensor is in communication with the chamber and configured to detect presence of the electrolyte.

In further features, the sensor includes a photoionization detector volatile organic compound sensor in communication with the chamber.

In further features, the sensor includes a thermal conductivity detector volatile organic compound sensor in communication with the chamber.

In further features, the sensor includes a mass spectrometer volatile organic compound sensor in communication with the chamber.

In further features, the sensor includes an infrared photocell sensor configured to detect the electrolyte, the sensor in communication with the chamber.

In further features, the sensor includes at least one of a metal oxide semiconductor vapor sensor in communication with the chamber, and a sorptive polymer capacitive thin film vapor sensor in communication with the chamber.

The present disclosure also includes, in various features, a system configured to detect leakage of an electrolyte from a prismatic battery cell. The system includes: a probe configured to contact the prismatic battery cell and create an air-tight connection between the probe and the prismatic battery cell over a fill port of the prismatic battery cell that has been closed with a seal; a pump in fluid communication with the probe, the pump configured to draw a vacuum through the probe; a housing defining a chamber including a window that is transparent to infrared radiation, the probe extends from the housing, the pump is connected to the housing to draw the vacuum through the probe into the chamber; and an infrared camera pointing at the window, the infrared camera configured to detect the electrolyte within the chamber pulled from the prismatic battery cell through the seal of the fill port by the vacuum generated by the pump, presence of the electrolyte within the chamber is indicative of the seal of the fill port of the prismatic battery cell being compromised.

In further features, a volatile organic compound sensor is in communication with the chamber and configured to detect presence of the electrolyte.

In further features, the infrared camera includes a filter configured to block infrared radiation outside of a wavelength range of 7-12 μm.

The present disclosure also provides for a method for detecting leakage of electrolyte out of a prismatic battery cell. The method includes: moving a probe of a test system into contact with an exterior case of the prismatic battery cell over a fill port of the prismatic battery cell that has been closed with a seal to create an air-tight connection between the probe and the exterior case; activating a pump to draw a vacuum from the fill port through the probe and through a housing of the test system defining a chamber including a window; and monitoring the chamber for a presence of the electrolyte with an infrared camera pointed at the window, the presence of the electrolyte within the chamber detected by the infrared camera is indicative of the fill port of the prismatic battery cell being compromised.

In further features, the method includes monitoring the vacuum for presence of the electrolyte using a volatile organic compound sensor.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an exemplary prismatic battery cell;

FIG. 2 is a perspective view of an exemplary test system in accordance with the present disclosure configured to identify electrolyte leakage from the battery cell of FIG. 1

FIG. 3 is a perspective view illustrating area 3 of FIG. 2; and

FIG. 4 is a perspective view of another test system in accordance with the present disclosure configured to identify electrolyte leakage from the battery cell of FIG. 1.

In the drawings, reference numbers may be reused to identify similar and/or identical elements.

### DETAILED DESCRIPTION

The present disclosure is directed to systems and methods for detecting leakage of electrolyte from a battery cell, such as electrolyte vapor. The systems and methods may be used to test any suitable battery cells configured to power any suitable device. The battery cells may prismatic battery cells, for example. The battery cells may be configured to power any suitable device, such as a vehicle. With respect to vehicles, the battery cells may be configured to power battery electric vehicles (BEVs), plug-in hybrid electric vehicles (PHEVs), or hybrid electric vehicles (HEVs), for example. The battery cells may be configured for any other suitable non-automotive use as well. The systems and methods of the present disclosure are thus applicable to automotive and non-automotive applications.

The battery cells may be manufactured using any suitable manufacturing process. Exemplary manufacturing processes include filling a battery cell case with electrolyte through a fill port, and then sealing the fill port with a weld or any other suitable seal. The present disclosure provides for systems and methods for testing the integrity of the battery cells, such as the integrity of the seal of the fill port. The testing may be performed by any suitable sensor, such as an infrared camera sensor configured to sense electrolyte vapor that has been pulled from the battery into a transparent chamber with a vacuum. Any other suitable electrolyte sensor may be used, examples of which are set forth therein.

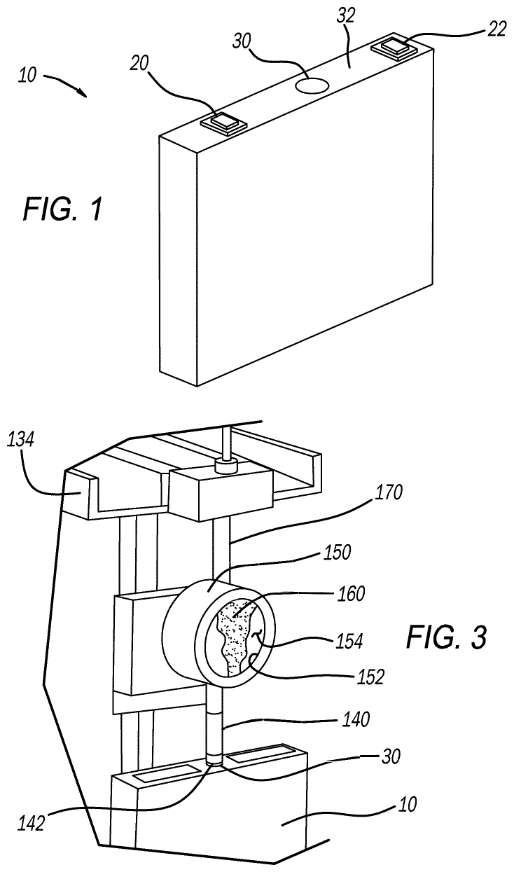

FIG. 1 illustrates an exemplary battery cell 10 configured as a prismatic battery cell. The battery cell 10 may be configured for powering a vehicle, such as any suitable battery electric vehicle (BEV), plug-in hybrid electric vehicle (PHEV), or hybrid electric vehicle (HEV), for example. The battery cell 10 includes, in part, a positive terminal 20 and a negative terminal 22. A fill port 30 for filling the battery cell 10 with an electrolyte is defined by an outer casing 32 of the battery cell. The fill port 30 is sealed closed in any suitable manner, such as with a weld. Within the casing 32 of the battery cell 10 are anodes and cathodes. The casing 32 is filled with an electrolyte through the fill port 30. After the electrolyte is added, the fill port 30 is sealed with the weld or in any other suitable manner.

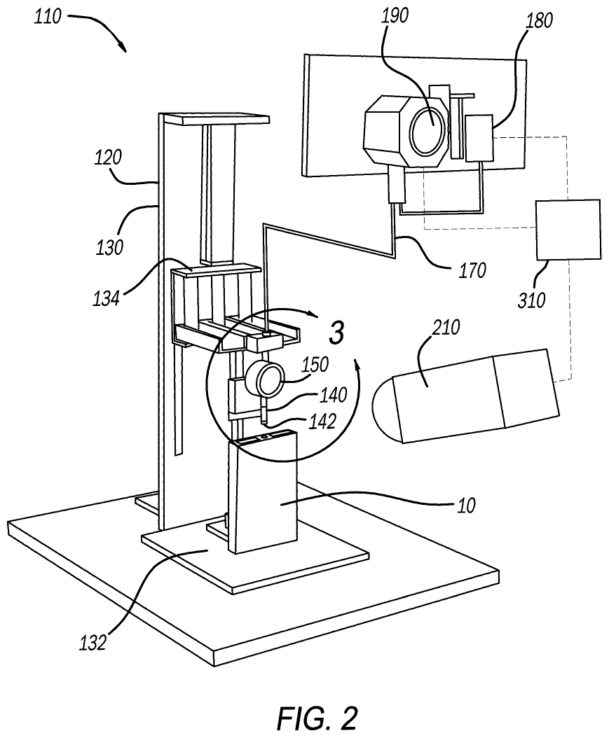

FIG. 2 illustrates a test system 110 in accordance with the present disclosure. The test system 110 is an exemplary test system configured to detect leakage of electrolyte out from within the casing 32, such as leakage of electrolyte vapor through the weld sealing the fill port 30. The system 110 includes a testing fixture 120. Included with the testing fixture 120 is a tower 130 extending from a base 132. A carrier 134 is mounted to the tower 130, and movable up and down along the tower 130 in any suitable manner, such as by any suitable pneumatic cylinder.

With continued reference to FIGS. 1 and 2, and additional reference to FIG. 3, a probe 140 is mounted to the carrier 134. The probe 140 includes a distal tip 142 at an end of the probe 140. The carrier 134 moves the probe 140 up and down. In a downward position, the distal tip 142 seals against the casing 32 around the fill port 30. The distal tip 142 may include a rubber seal, for example, to create an air-tight seal against the casing 32 over the fill port 30.

The probe 140 extends from a housing 150, which is generally configured as a bulb housing. The housing 150 defines a chamber 152, which is configured to receive electrolyte 160 (such as electrolyte vapor, for example) from the battery cell 10, as described herein. A wall of the chamber 152 is, or includes, a window 154. The window 154 is transparent to infrared radiation at least in the range of 7-12 μm. The window 154 may be made of silicon glass, for example. The chamber 152 may have any suitable volume, such as a volume greater than that of the probe 140, such as more than ten times greater. The chamber 152 may have an aspect ratio of z height to horizontal width of 1.0 (e.g., a wand bulb or other bulbous shape).

The present disclosure further includes a pump 180. The pump 180 is connected to the housing 150 by way of any suitable connection, such as a connection tube 170. The pump 180 is in fluid communication with the chamber 152 by way of the connection tube 170, and in fluid communication with the probe 140 extending from the chamber 152. The probe 140 is itself in fluid communication with the chamber 152. The pump 180 is configured to draw a vacuum through the probe 140, the chamber 152, and the connection tube 170. The pump 180 is configured to pull a vacuum on the order of 0.1 psi-5.0 psi, such as 0.5 psi. for example, or any other suitable vacuum. Also in fluid communication with the chamber 152 by way of the connection tube 170, or any other suitable connection, is any suitable volatile organic compound (VOC) sensor 190, which is configured to detect presence of the electrolyte 160, as described herein.

Positioned adjacent to the housing 150 is a sensor configured to detect presence of the electrolyte 160 within the chamber 152. The sensor may be any suitable sensor, such as a camera 210. The camera 210 is an infrared camera pointed at the window 154. The camera 210 includes a filter configured to block infrared radiation outside of a wavelength range of 7-12 μm, for example.

The test system 110 is controlled by a control module 310. The control module 310 may be any control module suitable to control, for example, movement of the carrier 134 to raise and lower the probe 140 into cooperation with the casing 32 over the fill port 30, the pump 180, the VOC sensor 190, and the camera 210. Exemplary operation of the test system 110 by the control module 310 will now be described.

The battery cell 10 to be tested is transported to the test system 110 in any suitable manner. At the time of testing, the battery cell 10 will include an electrolyte, which was previously introduced into the casing 32 through the fill port 30. After the electrolyte was added, the fill port 30 was sealed in any suitable manner, such as with any suitable weld. The test system 110 is configured to test the integrity of the weld or other seal of the fill port 30.

With the battery cell 10 seated on the base 132 of the test station, the control module 310 is configured to lower the carrier 134 (such as by actuation of any suitable pneumatic cylinder). The carrier 134 is lowered until the distal tip 142 contacts the casing 32 of the battery cell 10 around the fill port 30 and forms a seal around the fill port 30, such as an air-tight seal.

After the distal tip 142 of the probe 140 is sealed to the casing 32 over the fill port 30, the control module 310 activates the pump 180 to draw a vacuum, such as a vacuum on the order of 0.5 psi. If the seal of the fill port 30 is not completely intact, the vacuum will draw electrolyte vapor out from within the casing 32 through the seal and into the chamber 152. Within the chamber 152, the electrolyte 160 (electrolyte vapor, for example) will be visible by the camera 210 through the window 154.

The control module 310 is configured to operate the camera 210 to scan for the electrolyte 160 within the chamber 152. The control module 310 is configured to operate the camera 210 to capture, and optionally save, infrared images (in the wavelength of 7-12 μm) of the chamber 152 taken through the window 154. The control module 310 is configured to save the images at any suitable storage device of the control module 310 (or associated with the control module 310). The control module 310 is configured to analyze the captured infrared images to ascertain whether or not the electrolyte 160 is present within the chamber 152. In a non-limiting example, an image analysis module of the control module 310 examines each infrared image captured by the camera 210 to evaluate infrared waves emanating out of the chamber 152 through the window 154.

An image analysis module of the control module 310 may use any suitable gas cloud modeling algorithm, for example, to locate the electrolyte 160 through the window 154. The control module 310 is configured to determine that the presence of the electrolyte 160 within the chamber 152 is due to leakage of the electrolyte 160 out from within the casing 32 of the battery cell 10, such as through a seal of the fill port 30 due to, for example, a crack in the seal. Upon detection of the electrolyte 160, the control module 310 is configured to generate an alert indicating that the seal of the fill port 30 may be leaking or otherwise compromised.

The test system 110 is further configured to test for the presence of the electrolyte 160 using the VOC sensor 190, which is in fluid communication with the chamber 152 by way of the connection tube 170. The VOC sensor 190 may be any suitable volatile organic compound sensor configured to identify the presence of the electrolyte 160. The control module 310 is in communication with the VOC sensor 190 and configured to activate the VOC sensor 190 during a test procedure. If the electrolyte 160 is drawn out from within the casing 32 by the vacuum, the electrolyte 160 will be pulled by the vacuum through the housing 150 and to the VOC sensor 190 through the connection tube 170. Upon detection of the presence of the electrolyte 160 by the VOC sensor 190, the control module 310 is configured to generate any suitable alert indicating that the seal of the fill port 30 may be leaking or otherwise compromised. The VOC sensor 190 may be used to detect the presence of the electrolyte 160 in addition to, or in place of, the camera 210.

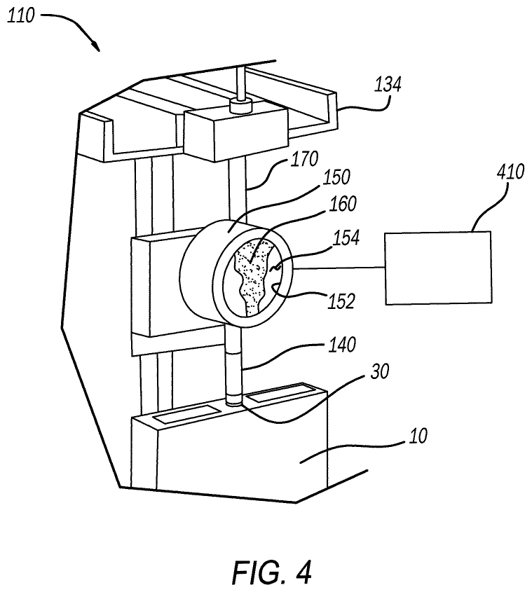

FIG. 4 illustrates the test system 110 configured with an alternate sensor 410 used in place of (or in addition to) the camera 210. The sensor 410 may be any sensor configured to identify the presence of the electrolyte 160 within the chamber 152. The sensor 410 may include at least one of the following: a photoionization detector volatile organic compound (VOC) sensor in communication with the chamber 152; a thermal conductivity detector VOC sensor in communication with the chamber 152; a mass spectrometer VOC sensor in communication with the chamber 152; an infrared photocell sensor configured to detect electrolyte vapor, the sensor in communication with the chamber 152; a metal oxide semiconductor vapor sensor in communication with the chamber 152; and a sorptive polymer capacitive thin film vapor sensor in communication with the chamber 152.

The present disclosure thus provides for systems and methods configured to detect electrolyte leakage (such as electrolyte vapor leakage) out from within the battery cell 10. Upon detection of the leakage, the specific battery cell 10 may be repaired or replaced. The ability to determine a specific battery cell 10 in need of repair or replacement enhances production and quality control.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system configured to detect leakage of an electrolyte from a battery cell, the system comprising:
a probe configured to contact the battery cell and create an air-tight connection between the probe and the battery cell over a fill port of the battery cell that has been closed with a seal;
a pump in fluid communication with the probe, the pump configured to draw a vacuum through the probe;
a housing defining a chamber including a window, the probe extends from the housing, the pump is connected to the housing to draw the vacuum through the probe into the chamber; and
a sensor configured to detect presence of the electrolyte within the chamber pulled from the battery cell through the seal of the fill port by the vacuum generated by the pump, presence of the electrolyte within the chamber is indicative of the seal of the fill port of the battery cell being compromised.

2. The system of claim 1, wherein the battery cell is a prismatic cell.

3. The system of claim 1, wherein the seal of the fill port includes a weld.

4. The system of claim 1, wherein the pump is configured to draw a vacuum of 0.1 psi.-5 psi.

5. The system of claim 1, wherein the window includes silicon glass that is transparent to infrared radiation.

6. The system of claim 1, wherein the chamber defines a chamber volume that is greater than a probe volume defined by the probe.

7. The system of claim 1, wherein the chamber has bulbous shape.

8. The system of claim 1, wherein the sensor includes an infrared camera pointing at the window, the infrared camera configured to detect the electrolyte within the chamber pulled out of the battery cell through the seal of the fill port by the vacuum generated by the pump.

9. The system of claim 8, wherein the infrared camera includes a filter configured to block infrared radiation outside of a wavelength range of 7-12 μm.

10. The system of claim 8, further comprising a volatile organic compound sensor in communication with the chamber and configured to detect presence of the electrolyte.

11. The system of claim 1, wherein the sensor includes a photoionization detector volatile organic compound sensor in communication with the chamber.

12. The system of claim 1, wherein the sensor includes a thermal conductivity detector volatile organic compound sensor in communication with the chamber.

13. The system of claim 1, wherein the sensor includes a mass spectrometer volatile organic compound sensor in communication with the chamber.

14. The system of claim 1, wherein the sensor includes an infrared photocell sensor configured to detect the electrolyte, the sensor in communication with the chamber.

15. The system of claim 1, wherein the sensor includes at least one of a metal oxide semiconductor vapor sensor in communication with the chamber, and a sorptive polymer capacitive thin film vapor sensor in communication with the chamber.

16. A system configured to detect leakage of an electrolyte from a prismatic battery cell, the system comprising:
a probe configured to contact the prismatic battery cell and create an air-tight connection between the probe and the prismatic battery cell over a fill port of the prismatic battery cell that has been closed with a seal;
a pump in fluid communication with the probe, the pump configured to draw a vacuum through the probe;
a housing defining a chamber including a window that is transparent to infrared radiation, the probe extends from the housing, the pump is connected to the housing to draw the vacuum through the probe into the chamber; and
an infrared camera pointing at the window, the infrared camera configured to detect the electrolyte within the chamber pulled from the prismatic battery cell through the seal of the fill port by the vacuum generated by the pump, presence of the electrolyte within the chamber is indicative of the seal of the fill port of the prismatic battery cell being compromised.

17. The system of claim 16, further comprising a volatile organic compound sensor in communication with the chamber and configured to detect presence of the electrolyte.

18. The system of claim 16, wherein the infrared camera includes a filter configured to block infrared radiation outside of a wavelength range of 7-12 μm.

19. A method for detecting leakage of electrolyte out of a prismatic battery cell, the method comprising:
moving a probe of a test system into contact with an exterior case of the prismatic battery cell over a fill port of the prismatic battery cell that has been closed with a seal to create an air-tight connection between the probe and the exterior case;
activating a pump to draw a vacuum from the fill port through the probe and through a housing of the test system defining a chamber including a window; and
monitoring the chamber for a presence of the electrolyte with an infrared camera pointed at the window, the presence of the electrolyte within the chamber detected by the infrared camera is indicative of the fill port of the prismatic battery cell being compromised.

20. The method of claim 19, further comprising monitoring the vacuum for presence of the electrolyte using a volatile organic compound sensor.
